(19) United States
(12) Patent Application Publication
(10) Pub. No.: US 2024/0058986 A1
(43) Pub. Date: Feb. 22, 2024

(54) ADDITIVE CONSTRUCTION OF STRUCTURES AND PRODUCTION OF ADDITIVE CONSTRUCTION MATERIALS

(71) Applicant: ICON Technology, Inc., Austin, TX (US)

(72) Inventors: Alexander Le Roux, Austin, TX (US); Evan Jensen, Austin, TX (US); Matthew Middle Name Carli, Austin, TX (US); Michael McDaniel, Austin, TX (US); Kunal Kupwade-Patil, Austin, TX (US)

(73) Assignee: ICON Technology, Inc., Austin, TX (US)

(21) Appl. No.: 18/109,823

(22) Filed: Feb. 14, 2023

Related U.S. Application Data
(60) Provisional application No. 63/309,951, filed on Feb. 14, 2022.

(51) Int. Cl. B28B 1/00; B28C 7/02; B28C 5/08

(52) U.S. Cl. CPC B28B 1/001; B28C 7/02; B28C 5/0893; B33Y 30/00

(57) ABSTRACT

Techniques for additive construction of structures and production of additive construction materials are described, including a 3D printing assembly including a container configured to store a material, a mixer configured to mix the material to provide an extrudable mix including cementitious material, and a dispenser configured to receive the flowable mix from the mixer and to provide the flowable mix under one or more controlled parameters to form a structure, and a controller configured to receive a value associated with a material property parameter of the material, to generate a mixture by inputting the value into a machine learning algorithm, the mixture being generated using, by the controller, another value associated with a control parameter configured to control operation of the 3D printing assembly, and using the 3D printing assembly to print a structure using the mixture.

### CROSS-REFERENCE TO RELATED APPLICATIONS

This application claims the benefit of copending U.S. Provisional Patent Application No. 63/309,951, filed on Feb. 14, 2022 and titled, “SYSTEM AND METHOD FOR PRODUCTION OF CONSTRUCTION MATERIALS,” all of which is herein incorporated by reference in its entirety for all purposes.

### FIELD

The disclosure relates to in-situ construction, and, more specifically, additive construction of structures and production of additive construction materials used with 3D printers and 3D printing assemblies and systems.

### BACKGROUND

Automated 3D construction applications typically require specific materials for optimized usage. 3D printing of construction materials is one of these automated technologies that rely on high-quality controlled materials to ensure a continuous quality print, e.g., extrusion of buildable mortar or concrete of uniform density, viscosity, rheology, etc. Unlike traditional concrete construction, 3D printing of concrete requires a specialized mix design to print a structure successfully.

### SUMMARY

Disclosed herein are techniques for additive construction of structures and production of additive construction materials used with 3D printers and 3D printing assemblies and systems, for example, a transportable, mobile construction printing system configured to produce 3D printed structures utilizing cementitious materials, with components of the mixture (e.g., aggregate, additives, regolith, and the like) sourced from a local terrestrial or non-terrestrial environment. The construction printing system includes a control system and one or more 3D (i.e., three dimensional) printers configured to extrude a cementious mix of materials. The control system may be configured to receive values for material properties of the locally sourced components and modifies a mixture to produce a flowable mixture advantageous for the local environment. In some examples, a “flowable mixture” or “flowable mix” may be used interchangeably with, without limitation, qualification, or restriction, an “extrudable mixture” or “extrudable mix” such as that extruded from a 3D printer or a nozzle thereof.

As additional description to the implementations described below, the present disclosure describes the following implementations. Other advantages will be apparent from the description, the drawings, and the claims. In a first implementation, disclosed herein is a construction mixing system for producing a mixture to form a structure, a portable mixing plant including a plurality of containers to receive and separately store a plurality of materials including at least a liquid, an aggregate, and a binding material, and a mixer to receive and mix the plurality of materials from the plurality of containers and to provide a flowable mix including cementitious material therefrom, and a controller configured to receive a value for a material property parameter of a material from the plurality of materials, generate a mixture by inputting the value for the material property parameter into a machine-learning trained algorithm, the mixture including values for a plurality of control parameters that control operation of the mixing plant and/or a 3D printing system that receives the flowable mix, and cause the mixing plant to operate according to the control parameters to generate the flowable mix and/or provide the mixture to the 3D printing system.

In some implementations, the control parameters can include one or more of a mix ratio, a mixing speed or a mixing time for the mixer. The control parameters can include one or more of a dispensing rate, a dispensing temperature, a pump speed, a pump pressure, a flow speed, a mixing speed, a mixing time, or material ratios for the 3D printing system. The plurality of materials can include one or more admixtures. In some examples, “admixture” may refer to an additive mixture or an additive material that, when included in a cementitious mix, can be used to alter, modify, or create different material characteristics of material to be flowed or extruded from a 3D printer. The control parameters can include an admixture dosage for the flowable mix. The controller can be configured to receive a value of an environmental parameter at the mixer or at a site of the 3D printing system, and to input the value for environmental parameter into the machine-learning trained algorithm. The environmental parameter can include one or more of ambient temperature, humidity, and wind speed. The controller can be configured to receive a value for a quality parameter of a dispensed mix from a site of the 3D printing system, and to train the algorithm using the value. The quality parameter can include one or more of viscosity, rheology, and/or solid content of the mix dispensed by the 3D printing system before curing. The controller can be configured to generate a modified mixture by inputting the value of the material property parameter into the algorithm, the modified mixture including modified values for the control parameters, and causing the 3D printing assembly to print the structure according to the modified mixture. The controller can be configured to determine if the value of the material property parameter exceeds a parameter threshold value and, responsive to the determination, transmit a notification indicative of the value of the material property parameter exceeding a parameter threshold value. The controller can be configured to receive the value for the quality parameter, and train the algorithm using the value in real time. The controller can be configured to determine if the value of the material property parameter exceeds a parameter threshold value and, responsive to the determination, transmit a notification indicative of the value of the material property parameter exceeding a parameter threshold value.

In a second implementation, the 3D construction printing system for dispensing of a flowable mix including cementitious material to form a structure, the system including a 3D printing assembly including plurality of containers to receive and separately store a plurality of materials including at least a liquid an aggregate, and a cementitious material, a mixer to receive and mix the plurality of materials from the plurality of containers and to provide a flowable mix including cementitious material therefrom, and a dispenser to receive the flowable mix from the mixer and deliver the flowable mix at controllable positions to form the structure. The 3D construction printing system Example 1a is the (system/method/apparatus) of example 1, where and a controller configured to receive a value for a material property parameter of a material from the plurality of materials, generate a mixture by inputting the value for the material property parameter into a machine-learning trained algorithm, the mixture including values for a plurality of control parameters that control operation of the 3D printing assembly, causing the 3D printing assembly to print a structure according to the mixture.

In alternative implementations, the controller can be configured to receive a value of an environmental parameter at the mixer or at a site of the 3D printing system, and to input the value for environmental parameter into the machine-learning trained algorithm. The environmental parameter can include one or more of ambient temperature, humidity, and wind speed. The controller can be configured to receive a value for a quality parameter of a dispensed mix from a site of the 3D printing system, and to train the algorithm using the value. The quality parameter can include one or more of viscosity, rheology, and/or solid content of the mix dispensed by the 3D printing system before curing. The controller can be configured to generate a modified mixture by inputting the value of the material property parameter into the algorithm, the modified mixture including modified values for the control parameters, and causing the 3D printing assembly to print the structure according to the modified mixture. The controller can be configured to receive the value for the quality parameter, and train the algorithm using the value in real time.

Particular implementations of the subject matter described in this specification can be implemented so as to realize one or more of the following technical advantages.
First, the construction printing system utilizes locally sourced components, thereby reducing the need for standardized materials that may require large shipping times, high shipping costs, or be difficult to source at remote job sites.
Second, the construction printing system provides job site flexibility by receiving the components from a variety of sources that can change as the printing job progresses. The job site environment can change from day to day and material properties of the materials may change as sources are changed. The construction printing system is adaptable to a variety of situations and materials, thereby increasing flexibility while creating the printed structure to a reliable standard.
Third, the construction printing system is adaptable to new situations as it is trained in varied environments using a variety of sources. The construction printing system receives information from installed sensors and/or user input at multiple stages to achieve increased quality in the printed structure, which can include higher durability, higher reliability, and increased system robustness.

The details of one or more embodiments are set forth in the accompanying drawings and the description below. Other features and advantages will be apparent from the description and drawings, and from the claims.

### BRIEF DESCRIPTION OF THE DRAWINGS

Various embodiments of the invention are disclosed in the following detailed description and the accompanying drawings:

FIG. 1 is a schematic diagram illustrating the various components and information flow of a construction material 3D printing system.

FIG. 2 is a schematic illustration of a construction material mixing system for use with a 3D printing system

FIG. 3 includes flow chart diagrams illustrating the process for receiving material to and printing from a construction material 3D printing system.

FIG. 4 is a schematic illustration of a construction material 3D printing mixing system.

FIG. 5 is a schematic illustration of a computer system.

In the figures, like references indicate like elements.

### DETAILED DESCRIPTION

At present, 3D printing of concrete utilizes a specialized mix design to print a structure successfully. The materials are generally sourced from reliable suppliers of standardized materials regardless of printing location. This is due, in part, to the organic and varying nature of the materials (“organic” in this context referring to natural geologically formation as opposed to human-synthesized). For example, the chemical and physical properties can vary, e.g., water content (absorption) of a sand material sourced from within 50 miles of the printing site may differ from the hydration of a sand material sourced from a vendor. Conventionally the mixture for a cementitious mixture and the desired physical properties (e.g., viscosity, rheology, pumpability, extrudability) of the mixture are selected before printing. This can create challenges to in-situ (e.g., in place) construction printing using local (e.g., <500 miles) or indigenous materials. In short, the locally available materials may not match the standardized materials, and thus when used in the predetermined mixture will not provide the desired physical properties. In some cases, the standard ranges of material that would be acceptable for conventional construction techniques have the potential to not provide the desired results for continuous automated printing, as the technical specifications may not be tight enough.

The disclosure outlined herein is a material delivery system that enables utilization of local materials to extrude flowable mixtures (e.g., a flowable mix including cementitious materials) to be used in construction, e.g., 3D printing, of structures, e.g., the foundation and walls of buildings, as well as other appurtenances to land that are typically formed of stone, brick or concrete, such as driveways, walkways, retaining walls, swimming pools, and the like, as well as infrastructure such as roads, sidewalks, bridges, dams, etc. In the case of printing structures, these flowable mixtures can be used for forming layered structures, e.g., printed structures, in varying environments. The material delivery system is transportable between locations, e.g., by use of a flat-bed truck or the like, and can receive supplies of incoming construction materials from local sources, including binders (e.g., cements, aluminosilicate sources), liquids, sands, admixtures, and filler materials. The material delivery system blends materials in either wet or dry conditions, thus facilitating adaptation to geographic location, on-site environmental conditions, or project parameters.

Examples of flowable mixtures depends on the desired printed structure, available resources, and chemical reaction which occurs during curing of the printed structure. In some implementations, the flowable mixtures includes metals, ceramics, carbon nanostructures, metallic powders, and/or ceramic powders.

The construction printing system described herein provides flexibility in the use of source construction materials from sources nearby the printing site. The sourced materials will be received by the construction printing system and stored in dedicated, categorized containers, e.g., silos, or tanks. These containers can be labeled according to the category of material stored, e.g., binders, fillers, and/or sands.

A digitized quality control (QC) process will be applied before the materials are transferred to a mixing system for blending. Procedures for screening the materials include (1) measuring and storing values for the material properties (referred to as material parameters) of the incoming materials to facilitate cross reference, indexing, and categorization with a control system; (2) establishing a quality control feedback loop to verify that incoming materials meet the mixture, e.g., specification, tolerance; and (3) allowing for mixture optimization based on an intended use and ambient conditions. In some implementations, the mixture is optimized in real-time.

While this specification contains many details, these should not be construed as limitations on the scope of what may be claimed, but rather as descriptions of features specific to particular examples. Certain features that are described in this specification in the context of separate implementations can also be combined. Conversely, various features that are described in the context of a single implementation can also be implemented in multiple embodiments separately or in any suitable subcombination.

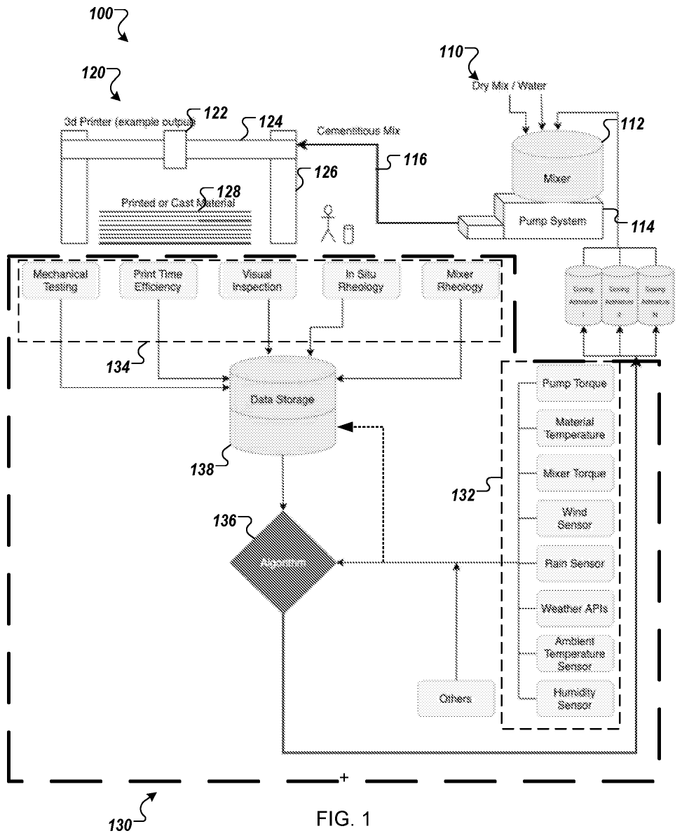

FIG. 1 is a system diagram illustrating various interconnected components of an exemplary 3D construction printing system 100 including a mixing system 110, a construction printer 120, and a control system 130. The construction printing system 100 is transportable to sites in varying environments, e.g., high/low temperature environments, high/low humidity environments, high/low wind speed environments, high/low elevation environments. In some implementations, the construction printing system 100 is assembled at a site. For example, the construction printing system 100 can be modular such that it can be disassembled, e.g., using conventional tools and without damage, into major components, e.g., the containers, mixer, etc., that can be transported, by flat-bed truck or the like, and then reassembled at a new location.

Although FIG. 1 illustrates the construction printer 120 as part of the construction printing system 100, it should be understood that the mixing system 110 and construction printer 120 need not be located at the same site; they could be separated, e.g., by up to 10 miles, up to 25 miles. In other implementations, local resources are received from a serviceable area nearest to the construction site, e.g., the nearest source of the materials of the flowable mix. In further implementations, local resources are received according to one or more industrial standards for sustainability, e.g., LEED credentials. In this case, the flowable mixture can be fabricated at the mixing system 110 and then transported, e.g., by cement truck if a wet mixture or in a hopper truck if a dry mixture, to the building site with the construction printer.

Materials to construct the printed structure 128 are received from local sources within a distance the mixing site or construction site. In some implementations, the materials are received from a local source that is within about 500 miles of the construction printing system 100 (or of the mixing system 110 if the construction printer is remote). For example, the local source can be within about 100 miles, e.g., within about 50 miles. As an example, a construction printing system 100 assembled in a desert region receives sands sourced from desert, e.g., desert sands. As a second example, a construction printing system 100 assembled in a coastal region receives water from a coastal source, e.g., ocean water. As a third example, the system 100 can receive repurposed materials such as ground, processed concrete, recycled plastics, or consumer waste. It would not be unusual for at least some local sources to be farther from the mixing site than the construction site, although such local sources would still be expected to be closer than sources for equivalent conventional standardized materials.

The construction printing system 100 described with reference to FIG. 1 receives mixture materials including different types of cements (e.g., blended cements, Portland cements), filler materials or supplementary cementitious materials (e.g., fly ash, bottom ash, metakaolin, Ground Granulated Blast Furnace Slag (GGBFS), rice husk ash, biomass ash (e.g., ash from burnt wood or timber), volcanic ash, silica fume, soils, silica fume, local soils, municipal solid waste incinerator (MSWI) ash (e.g., incinerator ash), shale quarry dust), aggregates such as ground natural aluminosilicate rock or sands (e.g., river sands, or beach sands), and/or water to produce a cementitious mixture as the flowable mixture.

A mixing system 110 receives the mixture materials from a variety of sources, such as water reservoirs, trucks, or pipes. The mixing system 110 includes one or more containers, e.g., silos, or tanks, for holding the received mixture materials. The control system 130 for the construction printing system 100 stores, such as in a non-transitory computer readable medium, a category label for each container, indicative of the material stored in the container. For example, the control system 130 of the construction printing system 100 stores an exemplary category label such as binder, filler, liquid, aggregate, and/or sand, for each container.

The materials used in the construction printing system 100 have material properties (referred to as material parameters) which affect the outcome of the mixing and printing processes. The specific material parameters may depend on the category of the material. For example, material parameters for sands could include material composition (e.g., percentages of various silicates), grain size (fineness), density, and moisture absorption. Similarly, material parameters for aggregates could include material composition and particle size. As another example, material parameters for binders include chemical composition (oxide and phase composition of cements), reactivity (e.g., cement reactivity, reactivity of the binder to form the chemical hydrates), and physical properties (density, loss of ignition), and/or particle size. As another example, material parameters for water could include pH level, salinity, calcium carbonate levels, etc. As another example, material parameters for admixtures could include temperature, viscosity, and/or solids content. As described below, these material parameters can be measured as part of the digitized quality control (QC) process and stored for subsequent use by the control system 130.

The materials used in the mixing system 110 are dispensed into the vessel 112 according to a mixture to produce the cementitious mixture. The amounts of each material (e.g., sand, cement, water) in the mixture can depend on one or more material parameters of the materials. For example, sand sourced from a desert region has lower absorption (e.g., water entrained in the sand) than sand sourced from a coastal or river region (e.g., higher absorption). Thus, use of sand sourced from a coastal or river region may mean a mixture needs less water to provide a cementitious mixture having the desired qualities. The sand geometry and particle size will impact water ratios as it relates to surface area and compaction of the mix, more powder may require more water content in the cementitious mixture.

The vessel 112 includes an agitator, e.g., an augur or other mixing system, such as a paddle system, which agitates the materials dispensed into the vessel 112 to create the cementitious mixture. The cementitious mixture is a composite material composed of the construction materials dispensed into the vessel 112, which can include fine and coarse aggregate (e.g., sands, stones) bonded together with wet materials (e.g., water, admixtures), and a cementitious material (e.g., Portland cement) that hardens (cures) over time.

The cementitious mixture can include additional materials, such as binders, accelerants, or other admixtures. Admixtures are materials are added to the concrete to produce certain characteristics not obtainable with plain concrete mixes (e.g., including only aggregate, cement, and water). The most common admixtures are retarders and accelerators. In normal use, admixture dosages are less than 5% by mass of cement and are added to the concrete at the time of batching/mixing. Other examples of admixtures include superplasticizers, hydration stabilizers, and/or viscosity modifying admixtures.

The output of the mixer 110 and/or construction printer 120, i.e., the cementitious mixture, will have various material qualities (referred to as physical parameters below). Examples of the physical parameters of the cementitious mixture include, for example, viscosity, rheology, pH level, cure rate, etc.

In addition, the site of the mixer 110 and/or construction printer 120 can be characterized by various environmental variables (referred to as environmental parameters). Examples of environmental parameters include air temperature, air humidity, wind speed, precipitation, etc., at the respective site.

The components of the construction printing system 100, e.g., the mixing system 110 and the construction printer 120, are connected to a control system 130 (e.g., a controller, such as a programmed general purpose computer) which controls, e.g., provides instructions to or electronically operates, the connected components. The control system 130 receives input related to the mix materials (e.g., values for the material parameters), the cementitious mixture (e.g., values for the physical parameters), and/or environment (e.g., values for the environmental parameters) of the construction printing system 100, e.g., of the mixing system and/or construction printer. The input can be received from sensors and/or from a user interface, and this data can be stored by the control system 130, such as in a non-transitory computer readable medium. The control system 130 receives and processes the input to operate or generate commands for the connected components. Although illustrated as a single system, functionality of the control system 130 can be distributed across multiple computers and need not be centralized at the mixing site or construction site.

The control system 130 includes, or is connected to, sensors 132 in the mixing system 110 and/or the construction printer 120, or other sensors connected to the construction printing system 100. Examples of sensors 132 include a torque sensor to measure motor torque of the mixer (which can provide a measure of viscosity), a temperature sensor to measure air temperature at the mixing site, an airflow sensor to measure wind speed at the mixing site, a humidity sensor, an optical sensor or spectrophotometric sensor to monitor the output mixture and generate optical data from which values for various physical properties can be derived, a flow sensor to measure flow rate from the mixer and/or construction printer, a level sensor which measures the level of material in one or more materials stored in or received by the printing system 100, or a pressure sensor to measure the pressure of the mixture in the mixer and/or construction printer. The sensors 132 collect data from the mixing system 110 and the construction printer 120 related to the processes of the construction printing system 100. The sensors 132 generate output based on the received data and transmit the output to the control system 130. Further examples of sensors 132 include microwave, and infrared sensors for sensing internal material properties and geometries.

The positioning of the sensors 132 within the printing system 100 can depend on their type and purpose. For example, some can be located for pre-screening of components, some can be located for processing and sorting of components, and/or some can be located for monitoring and determining information related to the plastic state of the cementitious mixture during mixing, pumping, or depositing.

The control system 130 receives user input 134 from users (e.g., technicians) related to the cementitious mixture, the materials, the printed structure 128, and/or the construction process. For example, a user can perform rheological testing (e.g., slump test) of the cementitious mixture and input rheology data from the test into the control system 130. In some implementations, the user input 134 includes user input, laboratory and/or testing results, in-situ data, environmental data, and/or rheology data. The control system 130 can receive the user input 134 from a wired or wireless device connected to the construction printing system 100, or over a network (e.g., the internet) from a remote user. In some implementations, the control system 130 processes the output from the sensors 132 and the user input 134 in real-time. The received output and/or user input 134 can alternatively be stored in a storage device 138 connected to the control system 130 to be processed at a different time.

The control system 130 receives output from the sensors 132 and/or user input 134 as data to be input to the algorithm 136. The control system 130 includes a machine-learning (ML) algorithm 136 which receives and processes the data and outputs a mixture (e.g., a mixture). In some implementations, the algorithm 136 is a supervised learning algorithm. In alternative implementations, the algorithm 136 is a logistic regression, or a random forest algorithm. The trained algorithm 136 produces a mixture that is expected to generate a flowable mixtures having a best match to target qualities, e.g., to values for one or more physical parameters, for producing printed structure 128 given the values for the local environmental parameters and/or material parameters as constraints. The “best match” should be understood as limited by computational power and time, and can depend on the distance metric and minimization-finding techniques employed, as well as on prior training of the algorithm.

In some implementations, the algorithm is initially trained based on previously collected training data. For example, flowable mixtures are produced in a laboratory environment across a range of values for each environmental, material or control parameter to generate a variety of mixtures, and the physical parameter of each mixture is measured. Thus, each mixture provides a tuple of values (including one or more values for one or more of the environmental, material or control parameters and values for one or more physical parameters), and collection of tuples can provide a training data set. The values in the training data set are used by the control algorithm, e.g., in a training mode such as back-propagation, to determine internal weights in the algorithm, e.g., a weight for each input at each node in a neural network.

In some implementations, the algorithm 136 includes a master mixture, e.g., a trained mixture, which includes default values for local parameters and system parameters to produce a default flowable mixture output, e.g., a flowable mixture output based on the pre-determined physical parameter values. Local parameters include variables related to the in-situ environment, local materials, cementitious mixture, and printed structure, e.g., environmental parameters, material parameters, and physical parameters. System parameters include variables related to the controllable mixing and printing parameters (e.g., control parameters).

The master mixture can include, but is not limited to, default values for any local and system parameter described herein, including default physical parameters (e.g., hydration, admixture chemistry, ash composition), default environmental parameters (e.g., precipitation, wind speed, wind direction, humidity, temperature), default mixing parameters (e.g., pump speed, pump pressure, flow speed, mixing speed, mixing time, material ratios, mix ratios), default physical parameters (e.g., viscosity, rheology values, cure rates of the uncured mixture, and/or compression strength or tensile or compression modulus of the cured material), or printing parameters (e.g., print speed, lift times, bead width, dispensing rate, dispensing temperature, or bead height). The default values of the parameters of the master mixture can be stored in the storage device 138, or received from a networked location. The master mixture is designed to produce a cementitious mixture having target qualities for producing a printed structure, such as printed structure 128, under these default values.

In operation, the algorithm 136 receives local values from the sensors 132 and/or the user input 134, e.g., physical values, environmental values, mixture values, or quality values as input. The algorithm 136 determines values for the control parameters, e.g., mixing and/or printing parameters, based on the respective weights and received local values. The algorithm 136 outputs a local mixture including the determined values for the control parameters.

In some implementations, the algorithm 136 receives local values from the sensors 132 and/or the user input 134. The system 100 updates the local and system weights stored in the algorithm 136 based on the received local values and outputs updated local mixtures based on the updated parameter weights. The algorithm 136 can be trained at intervals, e.g., before and after completing a printed structure 128, or, in some implementations, the algorithm 136 is trained in real time, e.g., during mixing of a cementitious mixture, or during printing of a printed structure 128, e.g., a feedback loop. Training the algorithm 136 using local values can increase the accuracy of desired material parameters of the flowable mixture and the printed structure 128.

For example, when the algorithm 136 receives output from sensors 132 and/or user input 134 indicative of low environmental temperatures (e.g., <20° C.). If properly trained, the algorithm will compensate for the slower cure rate that occurs at lower temperatures by generating a mixture for cementitious mixtures which increases the temperature of the cementitious mixtures delivered to the construction printer 120, and/or add a hardening accelerator admixture material to the cementitious mixture so as to increase the cure rate toward the target cure rate. As a second example, if properly trained, when the algorithm 136 receives output from sensors 132 and/or user input 134 indicative of wet materials having a pH higher than the target or default pH, the algorithm will produce a mixture including an admixture or adjusting a mix ratio for the cementitious mixture to neutralize the pH of the wet materials.

In some implementations, the algorithm 136 generates modifications to one or more default values of parameters of the master mixture to create modified parameter values. The algorithm 136 can store the modified parameter values (or the modifications to the default parameter values) in the storage device 138 and/or update the default parameters within the master mixture.

In some implementations, the control system 130 operates to perform quality control (QC) checks, such as QC checks on the received materials, the cementitious mixture, the dispensed mixture, or the printed structure 128. The control system 130 receives the output from the sensors 132 and the user input 134 and determines whether one or more local parameter values (e.g., values for material parameters of the received materials, temperature of the environment) is within a local parameter value range stored in the control system 130. For example, the control system 130 can determine that the received water from the local source has a high pH (e.g., 12) and is above the range stored for water pH. The control system 130 transmits a notification, such as a signal indicative of a failed quality control test, to a device for presentation to a user.

The control system 130 receives the modified mixture from the algorithm 136 and generates commands or directly operates the mixing system and/or construction printer based on the system values in the mixture. The commands control one or more functions of the construction printing system 100 according to the values, such as values for the mixing speed of the mixing system 110, a ratio at which to mix two or more materials, a time for which to mix the materials, a temperature at which to control the mixing process, or the position of the dispensing system 122.

The mixing system 110 receives the mixture materials through one or more receiving ports. In some implementations, the mixing system 110 includes an admixture system 115 holding one or more admixtures for mixing with the mixture materials. Examples of admixtures include hardening accelerators (e.g., calcium chloride, non-chloride accelerators such as calcium nitrate, sodium nitrate, shortcrete accelerators (silicate and aluminum salts), air entraining agents, defoamers, bonding agents (e.g., a polymer), corrosion inhibitors, crystalline admixtures, pigments, plasticizers (e.g., lignosulfonate), superplasticizers, pumping aids (e.g., thickeners), hydration stabilizers, water reducing admixtures, and retarders (e.g., sugar, sucrose, sodium gluconate, glucose, citric acid, and tartaric acid). In further examples, the mixer 110 c can modify the temperature of the water (e.g., chill or heat), grind aggregates to make a higher powder content, and/or modify the mixing shear to thin out and/or control activation of the admixtures.

The mixing system 110 receives the modified mixture which includes, but is not limited to, mixture material amounts, mixing times, mixing temperatures, admixture amounts, dispensing intervals, material addition times, target viscosity, target pumpability, or target hydration.

The mixing system 110 agitates (e.g., mixes) the materials according to the mixture. In some implementations, the mixing system 110 agitates dry materials (e.g., aggregates, powders) separately from wet materials (e.g., water, liquids) before agitating the dry and wet materials collectively. The mixing system 110 dispenses the mixture materials to a mixing vessel 112 which agitates the mixture material according to the modified mixture to produce the cementitious mixture.

A pump system 114 including one or more pumps receives the cementitious mixture from the mixing system 110. The pump system 114 pressurizes for cementitious mixture delivery to the construction printer 120. The pump system 114 is connected to the construction printer 120 through a piping system 116, including a series of pipes or hoses. The pump system 114 delivers the pressurized cementitious mixture to a dispensing system 122 of the construction printer 120. In alternative implementations which utilize flowable mixtures including non-cementitious binders, the dispensing system 122 can include one or more components to initiate the binding reaction at the time of dispensing. For example, the dispensing system 122 can dispense flowable mixtures including photocrosslinking materials and include a photon emitter (e.g., a laser) to initiate the crosslinking reaction in the flowable mixture to form the printed structure 128. In further implementations, cross-linking reactions and materials can be initiated thermally (e.g., heat) with a thermal emitter of the dispensing system 122, or chemical admixtures can be included in the mixture to initiate the cross-linking reaction.

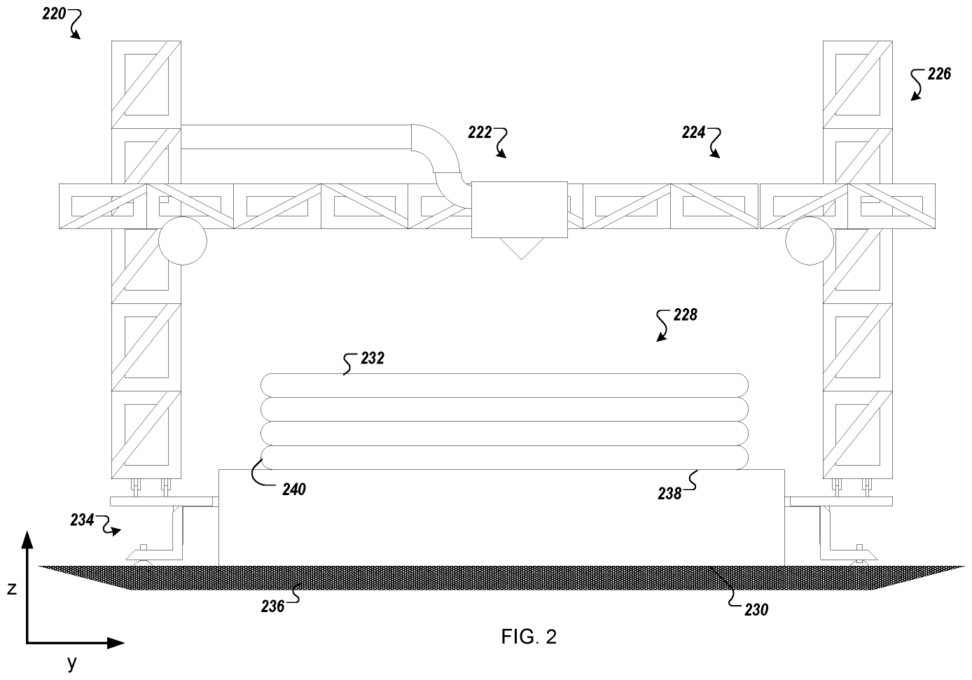

FIG. 2 is a schematic illustration of an exemplary construction printer 220, which can provide construction printer 120. The construction printer 220 includes vertical supports 226, a gantry 224 movably disposed on vertical supports 226, and a dispensing system 222. The construction printer 120 controls the motion of the dispensing system 222 and the gantry 224 along one or more orthogonal axes, e.g., an x-y-z Cartesian coordinate system, shown inset. The dispensing system 222 includes one or more actuators to induce motion with respect to the gantry 124. The gantry 224 includes one or more actuators to induce motion with respect to the vertical supports 226. In some implementations, the vertical supports 226 includes one or more actuators which impel motion with respect to the surface 430 to control the position of the dispensing system 222 along a first dimension, e.g., the x-dimension, while the gantry 224 moves with respect to the vertical supports 226 to control a second dimension, e.g., the z-position, while the dispensing system 222 moves with respect to the gantry 224 to control a third dimension, e.g., the y-position. Said another way, the actuators move the vertical supports 226 into controllable positions.

In some implementations, the vertical supports 226 are temporarily affixed to the surface 430. As shown in FIG. 2, a support structure 234 is temporarily affixed, e.g., with bolts or rivets, to the surface 430 and in contact with the ground 236 beneath the surface 430. The vertical supports 226 are connected to the support structure 234 which provides support for the motion of the construction printer 220.

The construction printer 220 controls motion of dispensing system 222 via the actuators of the dispensing system 222 and the gantry 224 relative to an exposed surface 238 and dispenses cementitious mixture in layers 232. The surface 238 can include a previously constructed foundation, such as foundation 230, or a prepared ground surface. The combined layers 232 form the printed structure 228. The construction printer 220 dispenses a first layer 440 of cementitious mixture from the dispensing system 222 on surface 238. The construction printer 220 dispenses additional layers 232 of the cementitious mixture to form the structure 228.

The construction printer 120 produces a printed structure 128 by extruding the cementitious mixture from the dispensing system 122 in a layered pattern. The pattern can be the same between layers, or the pattern can change between layers.

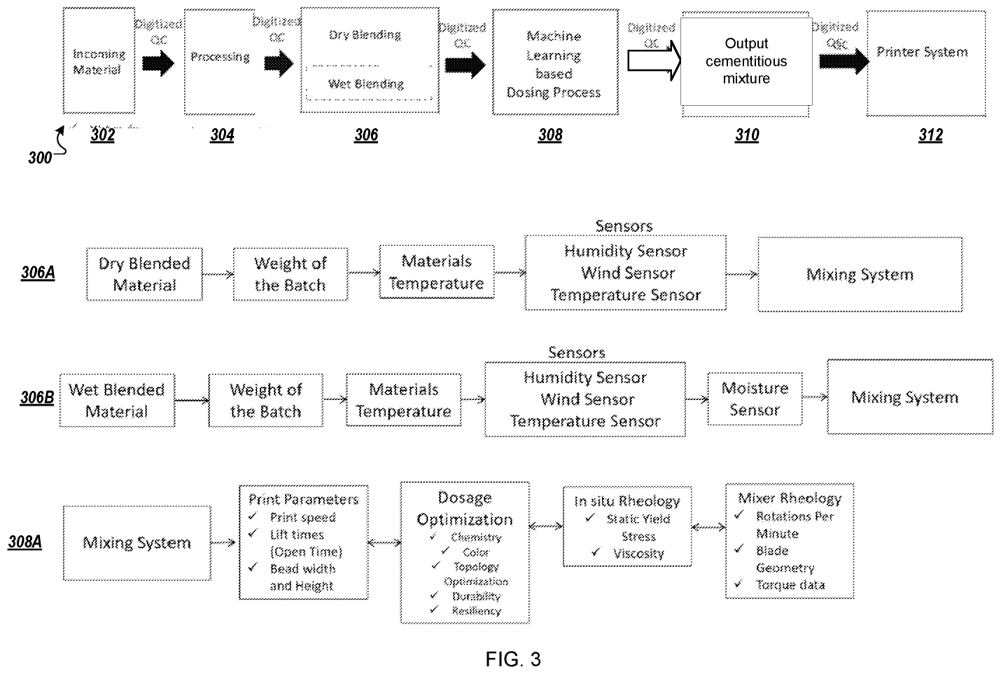

FIG. 3 is a series of flow chart diagrams of a printing process 300 for receiving incoming material, generating input related to physical parameters of the material, mixing of the material, and producing a printed structure, such as printed structure 128, from the mixture. The printing process 300 is described generally and can be implemented in the construction printing system 100 of FIG. 1.

The construction printing system 100 receives the materials from a local source (step 302). The construction printing system 100 receives values indicative of one or more physical parameters of the materials from the sensors 132 and/or user input 134. In some implementations, the materials are received from a local source that is within about 500 miles of the construction printing system 100 (e.g., within about 100 miles, within about 50 miles). In some implementations, the materials arrive in pre-measured quantities. In alternative implementations, the materials arrive continuously or are available on-demand. In some implementations, the system 100 receives further values indicative of environmental parameters, system parameters, quality parameters, or mixing parameters.

The system 100 processes the physical values and environmental values to determine if quality control check thresholds are exceeded (step 304). The control system 130 receives the values for the physical, environmental, system, quality, and/or mixing parameters. The control system 130 compares the received values to quality control thresholds stored in non-transitory medium and determines if the values exceed corresponding thresholds. If a parameter value exceeds an associated parameter threshold, the control system 130 transmits a notification indicating that the parameter has exceeded the quality control threshold.

The dry and wet materials are dispensed into the mixing vessel 112 and blended together in the mixing system 110 according to the mixture (step 306). The dry materials and the wet materials are blended separately before dispensing into the mixing vessel 112. Flow charts 306A and 306B illustrate exemplary physical and mixture parameters that are determined from the dry and wet blended materials, respectively. Referring to both 306A and 306B, values representing the weight and temperature of the received materials are determined from sensors 132 or user input 134. Referring the 306B, values representing the moisture of the wet materials are determined from sensors 132 or user input 134.

Referring again to both 306A and 306B, in some implementations, the sensors 132 output values indicative of environmental parameters, such as humidity, wind direction and speed, and ambient temperature. In some implementations, the sensors 132 output values indicative of one or more mixture parameters of the output cementitious material. For example, sensors 132 can output values indicative of the moisture (e.g., hydration) of the wet blended material. The output values indicative of for the physical parameters and the environmental parameters are transmitted to the control system 130.

Returning to printing process 300, the control system 130 receives the values for local and system parameters and determines a mixture (step 308). The control system 130 supplies the received values to the algorithm 136. The algorithm 136 produces a mixture including values for each system parameter according to the provided local values. The control system 130 controls the system 100 according to the mixture. For example, the mixture is transmitted to the mixing system 110 which produces the cementitious mixture according to the mixture.

Element 308A is a flow chart diagram depicting some local and system parameter values that the control system 130 receives and on which the mixture depends. For example, the mixture may depend on print parameters, such as print speed, lift times (e.g., 5 minutes, 10 minutes, or 60 minutes), bead width, or bead height. The mixture may depend on dosage parameters such as water chemistry (e.g., pH, mineral content), color, topology, durability, or resiliency. The mixture may depend on rheology, e.g., static yield stress, or viscosity, or mixer rheology, e.g., mixing vessel 112 rotations per minute (RPM), mixing blade geometry, or mixing blade torque data.

The cementitious mixture is output from the mixing system 110 (step 310). The cementitious mixture is dispensed from the mixing vessel 112 by the pump system 114. A construction printer 120 includes a pumping mechanism for receiving the cementitious mixture.

The construction printer 120 receives the cementitious mixture from the mixing system 110 via the piping system 116 from the pump system 114 (step 312). The construction printer 120 dispenses the cementitious mixture to produce the printed structure 128.

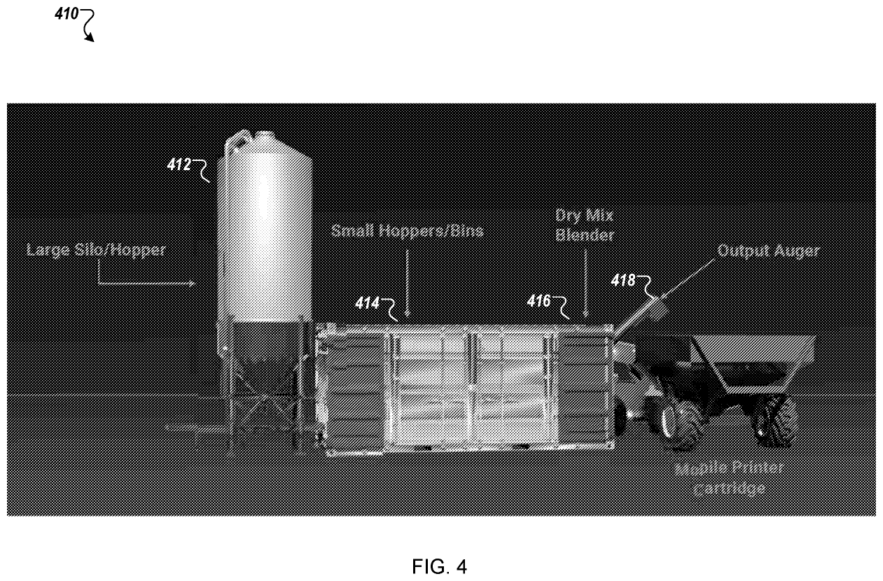

FIG. 4 is a schematic representation of an example mixing system 410, which can provide mixing system 110. The mixing system 410 includes a dry storage unit 412 in which volumes of dry materials are stored for supply to the mixing system 410. The mixing system 410 includes one or more additional storage units 414 in which volumes of dry or wet materials are stored for supply to the mixing system 410. The mixing system 410 includes a mixing vessel 416 for receiving the dry/wet materials of the dry storage unit 412 and the storage units 414 and producing a cementitious mixture. The mixing system 410 includes an output 418, e.g., an output augur, for dispensing the cementitious mixture.

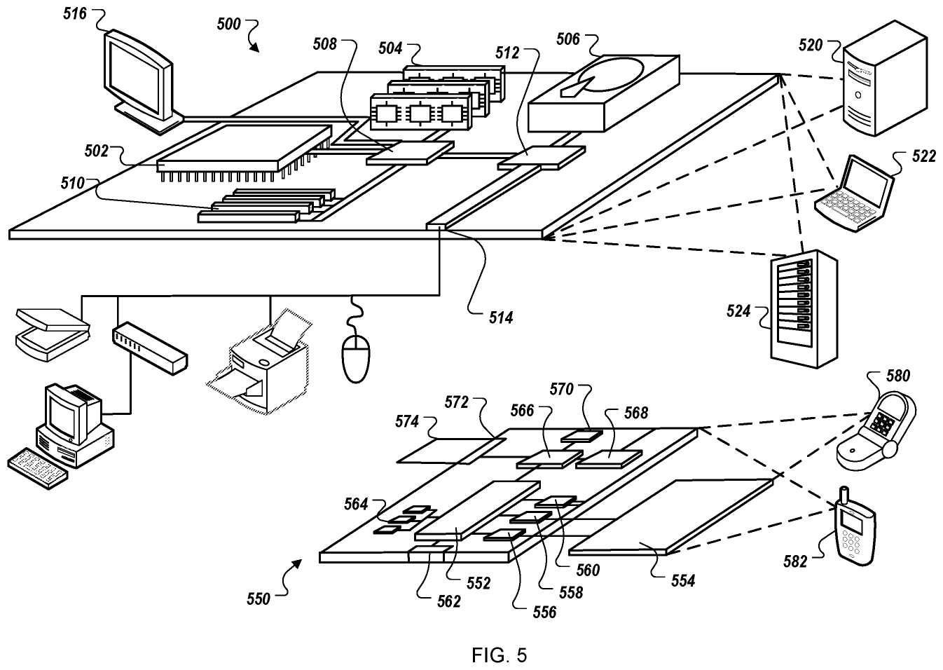

As noted previously, the systems and methods disclosed above utilize data processing apparatus to implement aspects of the localized construction printing system 100 described herein. FIG. 5 shows an example of a computing device 500, e.g., control system 130, and a mobile computing device 550 that can be used as data processing apparatuses to implement the techniques described here. The computing device 500 is intended to represent various forms of digital computers, such as laptops, desktops, workstations, personal digital assistants, servers, blade servers, mainframes, and other appropriate computers. The mobile computing device 550 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 500 includes a processor 502, a memory 504, a storage device 506, a high-speed interface 508 connecting to the memory 504 and multiple high-speed expansion ports 510, and a low-speed interface 512 connecting to a low-speed expansion port 514 and the storage device 506. Each of the processor 502, the memory 504, the storage device 506, the high-speed interface 508, the high-speed expansion ports 510, and the low-speed interface 512, are interconnected using various busses, and may be mounted on a common motherboard or in other manners as appropriate. The processor 502 can process instructions for execution within the computing device 500, including instructions stored in the memory 504 or on the storage device 506 to display graphical information for a GUI on an external input/output device, such as a display 516 coupled to the high-speed interface 508. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 504 stores information within the computing device 500. In some implementations, the memory 504 is a volatile memory unit or units. In some implementations, the memory 504 is a non-volatile memory unit or units. The memory 504 may also be another form of computer-readable medium, such as a magnetic or optical disk.

The storage device 506 is capable of providing mass storage for the computing device 500. In some implementations, the storage device 506 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 502), perform one or more methods, such as those described above. The instructions can also be stored by one or more storage devices such as computer- or machine-readable mediums (for example, the memory 504, the storage device 506, or memory on the processor 502).

The high-speed interface 508 manages bandwidth-intensive operations for the computing device 500, while the low-speed interface 512 manages lower bandwidth-intensive operations. Such allocation of functions is an example only. In some implementations, the high-speed interface 508 is coupled to the memory 504, the display 516 (e.g., through a graphics processor or accelerator), and to the high-speed expansion ports 510, which may accept various expansion cards (not shown). In the implementation, the low-speed interface 512 is coupled to the storage device 506 and the low-speed expansion port 514. The low-speed expansion port 514, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. In addition, it may be implemented in a personal computer such as a laptop computer 522. It may also be implemented as part of a rack server system 524. Alternatively, components from the computing device 500 may be combined with other components in a mobile device (not shown), such as a mobile computing device 550. Each of such devices may contain one or more of the computing device 500 and the mobile computing device 550, and an entire system may be made up of multiple computing devices communicating with each other.

The mobile computing device 550 includes a processor 552, a memory 564, an input/output device such as a display 554, a communication interface 566, and a transceiver 568, among other components. The mobile computing device 550 may also be provided with a storage device, such as a micro-drive or other device, to provide additional storage. Each of the processor 552, the memory 564, the display 554, the communication interface 566, and the transceiver 568, are interconnected using various buses, and several of the components may be mounted on a common motherboard or in other manners as appropriate.

The processor 552 can execute instructions within the mobile computing device 550, including instructions stored in the memory 564. The processor 552 may be implemented as a chipset of chips that include separate and multiple analog and digital processors. The processor 552 may provide, for example, for coordination of the other components of the mobile computing device 550, such as control of user interfaces, applications run by the mobile computing device 550, and wireless communication by the mobile computing device 550.

The processor 552 may communicate with a user through a control interface 558 and a display interface 556 coupled to the display 554. The display 554 may be, for example, a TFT (Thin-Film-Transistor Liquid Crystal Display) display or an OLED (Organic Light Emitting Diode) display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may provide communication with the processor 552, so as to enable near area communication of the mobile computing device 550 with other devices. The external interface 562 may provide, for example, for wired communication in some implementations, or for wireless communication in other implementations, and multiple interfaces may also be used.

The memory 564 stores information within the mobile computing device 550. The memory 564 can be implemented as one or more of a computer-readable medium or media, a volatile memory unit or units, or a non-volatile memory unit or units. An expansion memory 574 may also be provided and connected to the mobile computing device 550 through an expansion interface 572, which may include, for example, a SIMM (Single In Line Memory Module) card interface. The expansion memory 574 may provide extra storage space for the mobile computing device 550, or may also store applications or other information for the mobile computing device 550. Specifically, the expansion memory 574 may include instructions to carry out or supplement the processes described above, and may include secure information also. Thus, for example, the expansion memory 574 may be provide as a security module for the mobile computing device 550, and may be programmed with instructions that permit secure use of the mobile computing device 550. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier. The instructions, when executed by one or more processing devices (for example, processor 552), perform one or more methods, such as those described above. The instructions can also be stored by one or more storage devices, such as one or more computer- or machine-readable mediums (for example, the memory 564, the expansion memory 574, or memory on the processor 552). In some implementations, the instructions can be received in a propagated signal, for example, over the transceiver 568 or the external interface 562.

The mobile computing device 550 may communicate wirelessly through the communication interface 566, which may include digital signal processing circuitry where necessary. The communication interface 566 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 568 using a radio-frequency. In addition, short-range communication may occur, such as using a Bluetooth, Wi-Fi, or other such transceiver (not shown). In addition, a GPS (Global Positioning System) receiver module 570 may provide additional navigation- and location-related wireless data to the mobile computing device 550, which may be used as appropriate by applications running on the mobile computing device 550.

The mobile computing device 550 may also communicate audibly using an audio codec 560, which may receive spoken information from a user and convert it to usable digital information. The audio codec 560 may likewise generate audible sound for a user, such as through a speaker, e.g., in a handset of the mobile computing device 550. Such sound may include sound from voice telephone calls, may include recorded sound (e.g., voice messages, music files, etc.) and may also include sound generated by applications operating on the mobile computing device 550.

The mobile computing device 550 may be implemented in a number of different forms, as shown in the figure. For example, it may be implemented as a cellular telephone 580. It may also be implemented as part of a smart-phone 582, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., an OLED (organic light emitting diode) display or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

In some embodiments, the computing system can be cloud based and/or centrally processing data. In such case anonymous input and output data can be stored for further analysis. In a cloud based and/or processing center set-up, compared to distributed processing, it can be easier to ensure data quality, and accomplish maintenance and updates to the calculation engine, compliance to data privacy regulations and/or troubleshooting.

A number of implementations have been described. Nevertheless, it will be understood that various modifications may be made without departing from the spirit and scope of the invention. For example:
Although the discussion above focuses on cementitious mixtures, other sorts of binders can be used, so the techniques may be applicable to plasters and grouts.
Although the discussion above focuses on 3D printing of structures, the techniques can still be useful to provide an improved “mixture” (e.g., mix ratios) for more conventional construction techniques, e.g., pouring of concrete into slabs defined by retaining walls, as well as application of materials by hand such as plastering of walls or grouting of seams.
The techniques may still be applicable even in the absence of a binder, e.g., for meta-materials which can undergo a phase transition under applied energy, such as being melted and solidifying as a solid structure. Again, in the situation of local sourcing of materials for construction, a mixture (e.g., mix ratios, intensity of applied energy) can be adjusted to compensate for constraints on available components so that the constructed structure better meets the desired specifications.

Accordingly, other implementations are within the scope of the following claims.

1. A system, comprising:
a portable mixing plant including a plurality of containers configured to receive and separately store a plurality of materials including at least a liquid, an aggregate, and a binding material, and a mixer configured to receive and to mix the plurality of materials from the plurality of containers and to provide a flowable mix including cementitious material; and
a controller configured to receive a value associated with a material property parameter of at least one of the plurality of materials, to generate a mixture by inputting the value into an algorithm, the mixture including another value associated with at least one of a plurality of control parameters configured to control operation of the mixing plant and a 3-D printing system configured to receive the flowable mix, and to generate the flowable mix from the mixing plant, the mixing plant being operated according to the control parameters, and to provide the mixture to the 3D printing system.

2. The system of claim 1, wherein the control parameters include one or more of a mix ratio, a mixing speed or a mixing time.

3. The system of claim 1, wherein the control parameters include one or more of a dispensing rate, a dispensing temperature, a pump speed, a pump pressure, a flow speed, a mixing speed, a mixing time, or material ratios.

4. The system of claim 1, wherein the plurality of materials include one or more admixtures.

5. The system of claim 4, wherein the control parameters include an admixture dosage associated with the flowable mix.

6. The system of claim 1, wherein the controller is configured to receive a value of an environmental parameter at the mixer or at the 3D printing system, and to input the value associated with an environmental parameter into the algorithm.

7. The system of claim 1, wherein an environmental parameter includes one or more of ambient temperature, humidity, and wind speed.

8. The system of claim 1, wherein the controller is configured to receive a value associated with a quality parameter of a dispensed mix from a site of the 3D printing system, and to train the algorithm using the value.

9. The system of claim 1, wherein the controller is configured to receive a value associated with a quality parameter, the quality parameter comprising one or more of a viscosity value, a rheology value, or a further value associated with a solid content of the mix dispensed by the 3D printing system before curing.

10. The system of claim 1, wherein the controller is configured to generate a modified mixture by inputting the value of the material property parameter into the algorithm, the modified mixture including one or more modified values associated with one or more of the plurality of the control parameters, and the 3D printing assembly printing the structure using the modified mixture.

11. The system of claim 1, wherein the controller is configured to receive the value associated with the quality parameter, and train in real-time the algorithm using the value.

12. The system of claim 1, wherein the controller is configured to determine if the value of the material property parameter exceeds a parameter threshold value and, responsive to the determination, transmit a notification indicating the value of the material property parameter exceeds a parameter threshold value.

13. A system, comprising:
a 3D printing assembly including a container configured to store a material, a mixer configured to mix the material to provide an extrudable mix including cementitious material, and a dispenser configured to receive the flowable mix from the mixer and to provide the flowable mix under one or more controlled parameters to form a structure; and
a controller configured to receive a value associated with a material property parameter of the material, to generate a mixture by inputting the value into a machine learning algorithm, the mixture being generated using, by the controller, another value associated with a control parameter configured to control operation of the 3D printing assembly, and using the 3D printing assembly to print a structure using the mixture.

14. The system of claim 13, wherein the material comprises a liquid.

15. The system of claim 13, wherein the material comprises an aggregate.

16. The system of claim 13, wherein the material comprises a cementitious material.

17. The system of claim 13, wherein the controller is configured to receive a further value associated with an environmental parameter at the 3D printing system, the further value being used by the machine learning algorithm and the controller to produce the mixture.

18. The system of claim 13, wherein the controller is configured to receive yet another value associated with a quality parameter of a dispensed mix from the 3D printing system, and to train the machine learning algorithm using the yet another value.

19. The system of claim 16, wherein the quality parameter includes still another value associated with one or more of viscosity, rheology, and/or solid content of the mix dispensed by the 3D printing system before curing.

20. The system of claim 16, wherein the controller is configured to generate a modified mixture by inputting the value of the material property parameter into the machine learning algorithm, the modified mixture including a modified value associated with one or more of the control parameters, and printing the structure using the 3D printing assembly configured to extrude the modified mixture.
